(19) United States
(12) Patent Application Publication
(10) Pub. No.: US 2005/0051620 A1
(43) Pub. Date: Mar. 10, 2005

(54) Personal data card processing system

(75) Inventors: Vincenzo Valentio DiLuoffo, Sandy Hook, CT (US); Craig Fellenstein, Brookfield, CT (US); Rick Allen Hamilton II, Charlottesville, VA (US); James Wesley Seaman, Falls Church, VA (US)

Correspondence Address: Robert V. Wilder;Attorney at Law, 4235 Kingsburg Drive, Round Rock, TX, 78681, US

(73) Assignee: International Business Machines Corporation, Armonk, NY (US)

(21) Appl. No.: 10/655,373

(22) Filed: Sep. 4, 2003

(51) Int. Cl. G06K 5/00

(52) U.S. Cl. 235/382

(57) ABSTRACT

In accordance with the present invention, there is provided a processing methodology for use in processing information received by a smart card which contains and supports a user personal data profile. Parameters specific to individual user's personal preferences, including travel related parameters and service preferences, are input and stored by the smart card and may be selectively read out and/or transmitted to instantaneously provide the individual's personalized data to various travel related processing systems. The smart card may also be used to present messages to the traveler from various travel services institutions, and also to be programmed by those institutions in order to access certain facilities available to the traveler.

### FIELD OF THE INVENTION

The present invention relates generally to information processing systems and more particularly to a methodology and implementation for enabling improved processing functionality using a smart card.

### BACKGROUND OF THE INVENTION

As the work force and even the personal lives of individuals becomes increasingly mobile, more and more time and services are being required in order to accommodate travelers both business and personal. Much of this travel time is used to input the traveler's personal information and preferences into processing systems along travel routes. Such systems are implemented in order to keep track of the individual's trip expenses and also to meet the traveler's personal needs during the trip.

Increasing numbers of travelers require temporary lodging at hotels and motels and the owners of such establishments must make the lodging experience as pleasant as possible for the traveler in order to be competitive. Most travelers have a varied set of repeatable environmental and other factors and preferences which they must manually manipulate each time they travel and at each stop they make. For example, a traveler must register at every hotel along his route and provide the same personal information every time. The traveler may wish to have his room temperature set to 72 degrees during the day but set to 68 degrees at night. Similarly, a traveler may wish to have a wake-up call at 6 AM every morning. Presently, the traveler must manually set all of these repeatable variables on at least a daily basis if not more frequently. Since most traveler's environmental or travel preferences and other personal data do not change from one location to another, much time is wasted in providing this personal preference information to establishments and service providers of many kinds, especially during extended business trips.

Thus, there is a need for an improved methodology and system for enabling improved processing of personal preference and other personal data for use by individuals and businesses in facilitating travel related services.

### SUMMARY OF THE INVENTION

In accordance with the present invention, there is provided a processing methodology and system for use in processing information received by a smart card which contains and supports a user personal data profile. Parameters specific to individual user's personal preferences, including travel related parameters and service preferences, are input and stored by the smart card and may be selectively read out and/or transmitted to instantaneously provide the individual's personalized data to various travel related processing systems. The smart card may also be used to present messages to the traveler from various travel services institutions, and also to be programmed by those institutions in order to access certain facilities available to the traveler.

### BRIEF DESCRIPTION OF THE DRAWINGS

A better understanding of the present invention can be obtained when the following detailed description of a preferred embodiment is considered in conjunction with the following drawings, in which:

FIG. 1 is a schematic diagram illustrating a system which may be used in an exemplary implementation of the present invention;

FIG. 2 is a schematic block diagram illustrating several of the major components of an exemplary computer system;

FIG. 3 is a schematic diagram illustrating various components within a user smart card which may be implemented in association with the present invention;

FIG. 4 is an illustration showing personal data items which may be stored by a smart card programmed in accordance with the present invention; and

FIG. 5 is a flow chart illustrating an exemplary methodology for implementing a smart card interfacing function in association with the present invention.

### DETAILED DESCRIPTION

It is noted that circuits and devices which are shown in block form in the drawings are generally known to those skilled in the art, and are not specified to any greater extent than that considered necessary as illustrated, for the understanding and appreciation of the underlying concepts of the present invention and in order not to obfuscate or distract from the teachings of the present invention.

The various methods discussed herein may be implemented within any communication device capable of receiving and transmitting signals utilized in computer-based applications over any inter-connection network, including but not limited to the Internet and the World Wide Web. In the present disclosure such devices include, but are not limited to, smart cards, cellular and other wireless devices, personal digital assistant devices, laptop and personal computers and also desk top computers and servers connected in local area or wide area networks. The present discussion will be directed to a server-based hotel processing application although it is understood that the principles involved in the present invention may be applied, inter alia, to all of the above noted receiving and transmitting devices and systems and associated with any product or service accessible by a user, including airplanes, cruise ships, rental cars and other forms of lodging and travel.

In an exemplary application of the present invention, a user would initially program the user's smart card with the user's personal preferences and personal data into the memory of the card. Participating facilities would be fitted or retrofitted or otherwise programmed with equipment capable of scanning or otherwise receiving selected information from the smart card and selectively providing further information and/or programming to the card for display and/or use by the user.

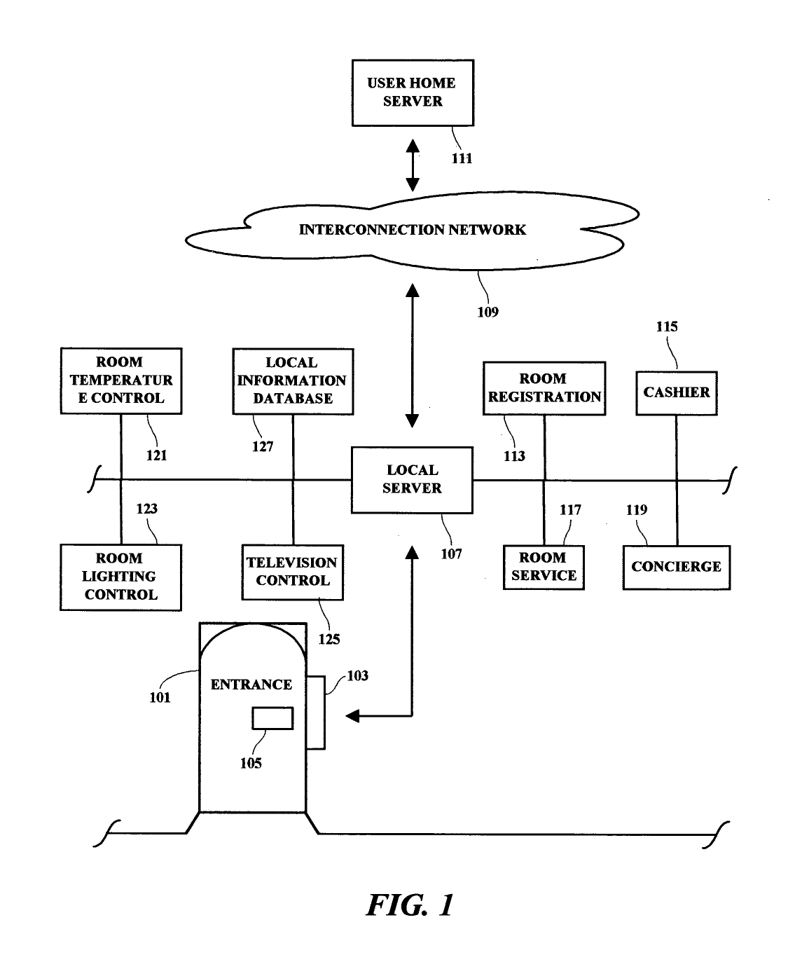

In FIG. 1, there is shown an exemplary environment in which the smart card and processing system of the present invention may be implemented. As shown, an entrance 101 to a hotel or motel includes a reading device 103 for reading information contained on a smart card 105. The reading device 103 may include a receiver capable of receiving signals transmitted from the smart card 105. The reading device 103 may also receive input information through a scanning process by which a bar or optical or magnetic code is read into the reading device by sliding the card along or into a slot in the reading device 103 or by hardwire connection by inserting a terminal on the card into a receiving terminal on the reading device. The reading device may be located at a facility entrance as illustrated or in a kiosk or other terminal station in the lobby of a hotel or motel or other facility.

The information received by the reading device 103 is transmitted to the local hotel server 107 in the present example. Server 107 is coupled to an interconnection network 109 such as the Internet, which in turn enables a connection to the user's home server 111. The user's home server 111 may be, for example, a corporate server which contains extensive user information. The user home server may be accessed for additional user information and/or verification of identification and/or reservation information in addition to information provided by the user's smart card 105. The local hotel server 107 is also connected to functional databases and controls for various hotel services. For example, as shown, the hotel server 107 is coupled to a room registration function 113, a cashier function 115, a room service function 117 and a concierge function 119. The hotel server is further coupled to room temperature control 121, room lighting control 123, room television control 125 and an information database 127.

In an exemplary operation, when a user or traveler enters a hotel facility 101, the user's personal identification and password are read by the reading device 103 and transmitted to the local hotel server 107. The server 107 then confirms the reservation, logs-in the user and assigns a room number using the room registration module 113 and sets the user's personal preferences which have been transmitted from memory in the user's personal data card 105. These preferences include, for example, the user's preference for room temperature, lighting, wake-up calls, in-room breakfast preferences, television preferences, etc., as may be contained in the user's personal preference database stored on the personal data card 105. The hotel server 107, through a wireless coupling, is then able to send an assigned room number to the user's smart card 105 such that the user knows what his room number is before he reaches the elevators. Further, the local server transmits a door lock code such as a coded sequence or other programming to the user's smart card 105 such that the user's own smart card may be used to open the door to the user's assigned hotel room by sliding the user's smart card through a reader at the entrance to the user's hotel room. At checkout, the lock code may be de-programmed from the user's card or merely inactivated at the hotel server and unable to open any hotel room after user check-out. Check-out may be accomplished automatically in accordance with a prearranged check-out date and time, or check-out may be accomplished by sliding the user's personal data card through a reader on the room television to confirm acceptance of charges which may be displayed on the room television. The hotel bill is processed by the hotel server through the cashier module 115 and may also be displayed and reviewed by the traveler using a personal display device such as the smart card or a personal computer (PC), cellular phone or personal digital assistant (PDA) device.

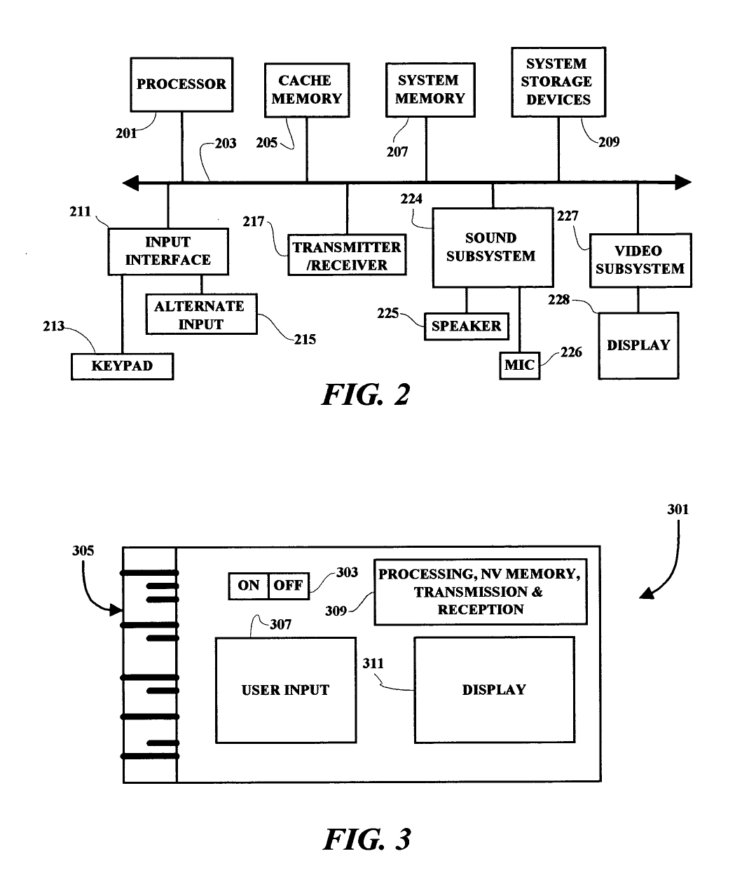

Several of the major components of an example of the server 107 are illustrated in FIG. 2. A processor circuit 201 is connected to a system bus 203. It is noted that the processing methodology disclosed herein will apply to many different bus and/or network configurations and is not limited to the configuration of the present example. A cache memory device 205 and a system memory unit 207 are also connected to the bus 203. The exemplary system also includes a system storage device 209. The system bus 203 is also connected through an input interface circuit 211 to a keypad or keyboard 213 as well as alternate input devices 215 which may include voice and/or stylus input devices, or touch-sensitive display screens which are capable of displaying menus for user selection of menu items as input. The bus 203 is also coupled to a transmitter/receiver section 217 which enables the receipt and transmission of digital information. The illustrated system may also be coupled to a network system through the transmitter/receiver section 217 and, as hereinafter explained, when implemented in a scaled down version within the user smart card, the receiver may also be used to receive signals effective to identify a user in the proximate area of the receiver 103. The exemplary system also includes a sound subsystem 224. Input means such as a microphone 226 and output means such as speaker 225 may also be included to enable a user to communicate with the device using voice commands and voiced menu and message playbacks. A video subsystem 227, which may include a graphics subsystem, is connected between the bus 203 and a display device 228. In general, the hotel server 107 includes the main components of the computer system shown in FIG. 2 but need not include all of the components illustrated. The receiver/reader device 103 is used for detecting ID numbers transmitted from a smart card or entered as a code on the card by a user.

FIG. 3 illustrates an exemplary “smart card” 301 which may be used in connection with the present invention. Other devices may also be implemented to practice the present invention. For example, software can be installed on existing pervasive/handheld devices such as a cell phone or PDA. With wireless networking capabilities, such devices can be enabled to transmit and receive signals which can be used for messaging and/or processing.

As shown in the smart card example in FIG. 3, the smart card 301 includes an on-off switch 303, a code segment 305 such as a bar code, magnetic code or optical code, a user input area 307, a section for processing, storing and transmitting and receiving signals 309 and a display area 311. Storing may be accomplished through the use of non-volatile memory such as flash memory which can receive, store and readout information, data and programming. The user input 307 may be embodied by a hardware keypad, or a virtual keypad could be presented on the display 311 for user interfacing using a stylus for example. In one exemplary embodiment of an automated gym system, when the card 301 is turned “ON”, the card begins to transmit a signal (ID signal) which is coded to identify the smart card owner using the card. That signal may be continuously transmitted on a repetitive basis so long as the ON/OFF switch is turned ON.

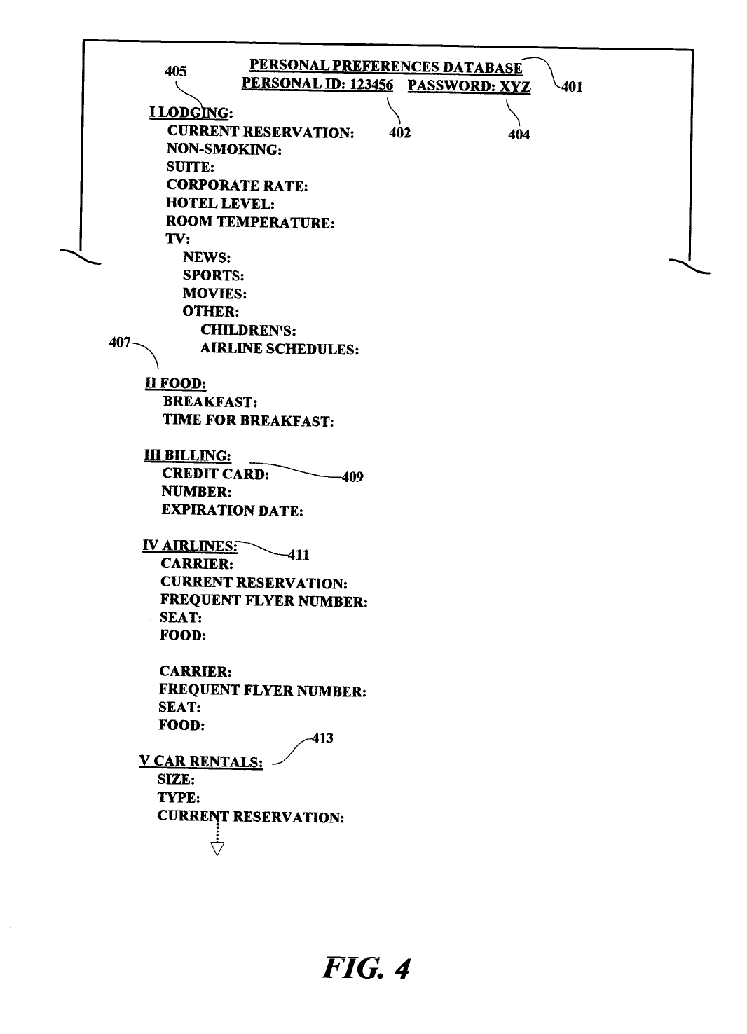

In FIG. 4, a personal preference database 401 is illustrated to identify several possible types of personal preference information that may be stored in memory 309 of a personal data card 301. As shown, the database 401 includes a personal identification (ID) number 402 and password 404 which are uniquely associated with a particular user. In addition, the database 401 contains a plurality of sections with each section identifying the user's personal preferences in predetermined environments and applications. In a first section I Lodging 405, information concerning user lodging preferences is stored. In this section, for example, information is stored concerning the user's current reservations, as well as the user's preferences related to smoking, suite types, rates, floor level, room temperature and television viewing. Television viewing preferences may include particular news preferences, sports, movies, airline schedules, etc. With these preferences transmitted to the hotel server 107, settings can be made in advance such that when the user or traveler arrives in his assigned room, the temperature, lighting and other preferences are already in place and operational so there is no waiting for the room environment to be adjusted manually by the traveler. Further, the television may already be turned ON and displaying the user preferred news station. This would be especially helpful when traveling in foreign countries. One of the user preferences stored in the personal data card can also be the user's preference for language. For example, the television would be programmed from the hotel server to display only English language programs if English were the designated preference language on the personal data card.

In another Section II Food 407, the user may indicate the type of breakfast and serving time for in-room breakfast serving. Similarly, preferences are stored for Billing 409, Airlines 411, Car Rentals 413, etc., such that personal preference information may be accessed, transmitted and implemented automatically at airline counters, rental car terminals and other service providers' terminal stations thereby obviating the need for the traveler to manually input preference or other personal information. Other preferences include but are not limited to day/night room temperature and transition times, alarm clock wake-up settings, water temperature settings for hot water, start-up time for in-room coffee maker, scheduling for outside services (i.e. 6 PM daily for masseuse scheduled via local server concierge function), set-up prefix for outbound telephone calls, etc. The above preferences can be expressed, inter alia, in “TLV” format and placed as an application on the smart card. The TLV format is “Tag, Length and Value”.

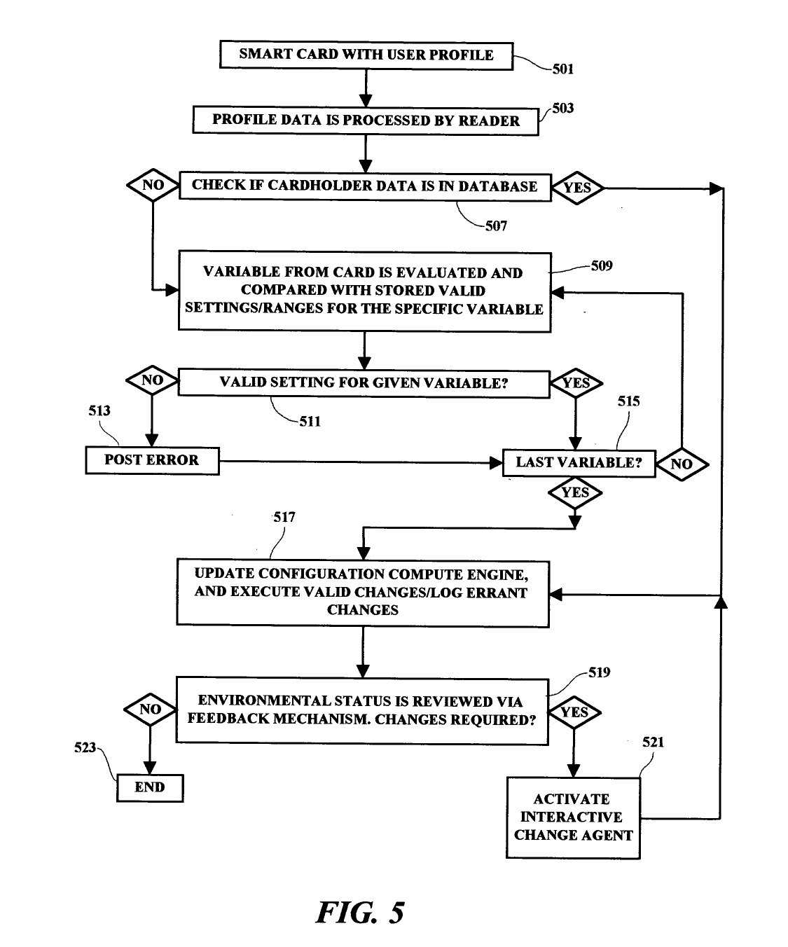

Referring to FIG. 5, there is shown a flow chart illustrating an exemplary flow for processing associated with the smart card or personal data card. Initially, a user programs his or her smart card with all of the user's personal preference information or profile including the preference items noted above. Participating facilities would be fitted or retrofitted with equipment capable of scanning and decoding the card. The smart card could be used for a plurality of functions including but not limited to payment for services and lodging as well as use as being programmed by a hotel server to act as a hotel room key for the user. As shown in FIG. 5, after the smart card is programmed with the user preference profile 501, the user preference data can be processed by a reader 503 and input into a hotel server processing system for example. The information is then checked to determine if the cardholder data is consistent with data contained in the server database 507. If not, each variable from the card is evaluated and compared with stored valid settings and ranges for the specific variable 509. When an invalid value of a variable is detected 511, an error message is posted 513. If it was initially determined that the cardholder preference information was already in the hotel server database 507 or after the last variable has been checked 515, a configuration compute engine (CCE) is updated, valid changes are executed and errant changes are logged 517. The CCE can be either the same computer reading the smart card data or a separate networked computer which actually executes the user preferences once they have been read-in and confirmed. The CCE is the system that actually interacts with the in-room devices/functions/services to configure them to the users preferences. The environmental status of the assigned hotel room is checked and compared with the user preferences 519 and if changes are required 519 an internal change agent is activated 521 to change settings to the preferred settings of the user and the system returns to update the preference configuration 517. After appropriate changes have been made and all of the user preferences have been set 519, the input preference processing is ended 523.

As noted earlier, the smart card, after the initial preference setting function, may be used for other functions as well, including but not limited to use as a hotel room key, for email type messages from the hotel server, for charging various hotel-related services, for extending reservations or making reservations at other facilities, and also for check-out.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored in a portable or fixed memory device, such as so-called “Flash” memory, from which it may be loaded into other memory devices and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

1. A method for processing user preference and related user information, said method comprising:
storing the user preference information on a wireless storage device;
selectively transmitting said user preference information from said wireless storage device to a receiving device at a service facility; and
transmitting said user preference information from said receiving device to a control system at said service facility for controlling selected services in accordance with said user preference information.

2. The method as set forth in claim 1 wherein said wireless storage device comprises a smart card including non-volatile, programmable memory means.

3. The method as set forth in claim 2 wherein said smart card further includes transceiver means selectively operable for transmitting and receiving information.

4. The method as set forth in claim 3 wherein said smart card further includes display means for displaying information received by said transceiver means.

5. The method as set forth in claim 4 wherein said smart card further includes processing means for processing information within said smart card.

6. The method as set forth in claim 5 wherein said smart card further includes input means for enabling user input to said wireless storage device.

7. The method as set forth in claim 1 wherein said service facility comprises a lodging facility, said control system being operable in response to receiving said user preference information for assigning a lodging unit to said user.

8. The method as set forth in claim 7 wherein said control system is further responsive to receiving said user preference information for implementing said user preferences for said lodging unit assigned to said user.

9. The method as set forth in claim 8 wherein said user preference information includes preferred temperature settings for said lodging unit.

10. The method as set forth in claim 8 wherein said user preference information includes preferred wake-up alarm settings for said lodging unit.

11. The method as set forth in claim 7 and further including:
transmitting lodging unit information from said control system to said smart card, said smart card being selectively operable to use said lodging unit information to unlock said lodging unit assigned to said user.

12. The method as set forth in claim 4 wherein service facility comprises a lodging facility, said control system being operable in response to receiving said user preference information for assigning a lodging unit to said user, said control system being further operable for:
transmitting address information identifying said lodging unit assigned to said user to said smart card; and
displaying said address information on said display means of said smart card.

13. The method as set forth in claim 12 wherein said smart card is enabled to use said address information to unlock said lodging unit assigned to said user.

14. The method as set forth in claim 13 wherein said lodging unit includes a unit receiving device at an entrance to said lodging unit, said unit receiving device being operable in response receiving said address information from said smart card for unlocking said lodging unit assigned to said user.

15. The method as set forth in claim 7 wherein said user preference information includes predetermined reservation information, said control system being selectively operable for automatically initiating user check-out processing in accordance with said predetermined reservation information.

16. The method as set forth in claim 1 wherein said service facility comprises a vehicle rental facility, said control system being operable in response to receiving said user preference information for assigning a rental vehicle to said user in accordance with said user preference information.

17. The method as set forth in claim 1 wherein said service facility comprises an airline facility, said control system being operable in response to receiving said user preference information for assigning reserved services to said user in accordance with said user preference information.

18. The method as set forth in claim 1 wherein said user preference information is stored in flash memory on said wireless storage device.

19. A processing system for processing user preference and related user information, said processing system comprising:
a wireless storage device for storing user preference information;
a receiving device at a service facility, said wireless storage device being selectively operable for transmitting said user preference information from said wireless storage device to said receiving device at said service facility; and
means for transmitting said user preference information from said receiving device to a control system at said service facility for controlling selected services in accordance with said user preference information.

20. A programmed media item selectively operable when read into memory of a computer system for generating program signals to enable processing of user preference and related user information, said program signals being further operable to enable:
receiving user preference information from a wireless storage device;
transmitting said user preference information from said receiving device to a control system at said service facility for controlling selected services in accordance with said user preference information.
